(19) United States
(12) Patent Application Publication
(10) Pub. No.: US 2013/0052306 A1
(43) Pub. Date: Feb. 28, 2013

(54) PET TREAT

(71) Applicants: DAVID CARRILLO, Cincinnati, OH (US); KENNETH BOWMAN, ALTA LOMA, CA (US)

(72) Inventors: DAVID CARRILLO, Cincinnati, OH (US); KENNETH BOWMAN, ALTA LOMA, CA (US)

(73) Assignee: UNITED PET GROUP, INC., CINCINNATI, OH (US)

(21) Appl. No.: 13/214,516

(22) Filed: Aug. 22, 2011

(51) Int. Cl. A23K 1/10; A23P 1/08; A23K 1/18

(52) U.S. Cl. 426/92; 426/641

(57) ABSTRACT

Provided are multi-layered pet treats containing meat and rawhide layers. In some aspects, the treats have an alternating layer structure containing at least layer of one or more dried meats and at least one layer of chopped rawhide pieces. Also provided are methods for making the treats, comprising layering the alternate layers in a mold, freezing the layers and slicing them prior to cooking. The treats provide high palatability and visual appeal to the pets, as well as conferring dental benefits on the pet.

### FIELD AND BACKGROUND

Pet treats are given to pets, such as dogs, to reward the pet. Pet treats have typically been prepared with the main goal of high palatability. Chicken jerky is a popular pet treat due to its high palatability to pets. However, there is a need in the market for an improved pet treat and an improved method of making a pet treat.

### SUMMARY

In an aspect of this disclosure, a pet treat is provided. The treat has a first slice segment having a first and a second peripheral edge. The first slice segment includes chopped rawhide pieces. The treat has a second slice segment having a first and a second peripheral side edge. The second slice segment includes dried meat. The first and the second slice segment are adjacently positioned and attached to each other at the second peripheral side edge of the first slice segment and first peripheral side edge of the second slice segment.

In another aspect, a method of making a pet treat is provided. The method comprises layering second layer on top of a first layer. One of the first and second layers includes dried meat. The other layer of the first and second layers contains chopped rawhide pieces in a binder. The method further comprises freezing the superimposed first and second layers and slicing the frozen superimposed first and second layers into relatively thin slice segments including portions of both of the first and second layers.

In yet another aspect, a pet treat comprising alternating slice segments of a first type and a second type is provided. The first and second types of slice segments have compositions different form each other. The first type of slice segment includes chopped rawhide pieces and the second type of slide segment includes dried meat. The pet treat has an appearance simulating the appearance of a slice of bacon.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A schematically illustrates a multi-slice segment treat in accordance with an embodiment of the disclosure.

FIG. 1B schematically illustrates the multi-slice segment treat of FIG. 1A.

FIG. 2 illustrates a method of preparing a multi-slice segment treat in accordance with an embodiment of the disclosure.

FIGS. 3A and 3B illustrate photographic examples of embodiments of the treat.

### DETAILED DESCRIPTION

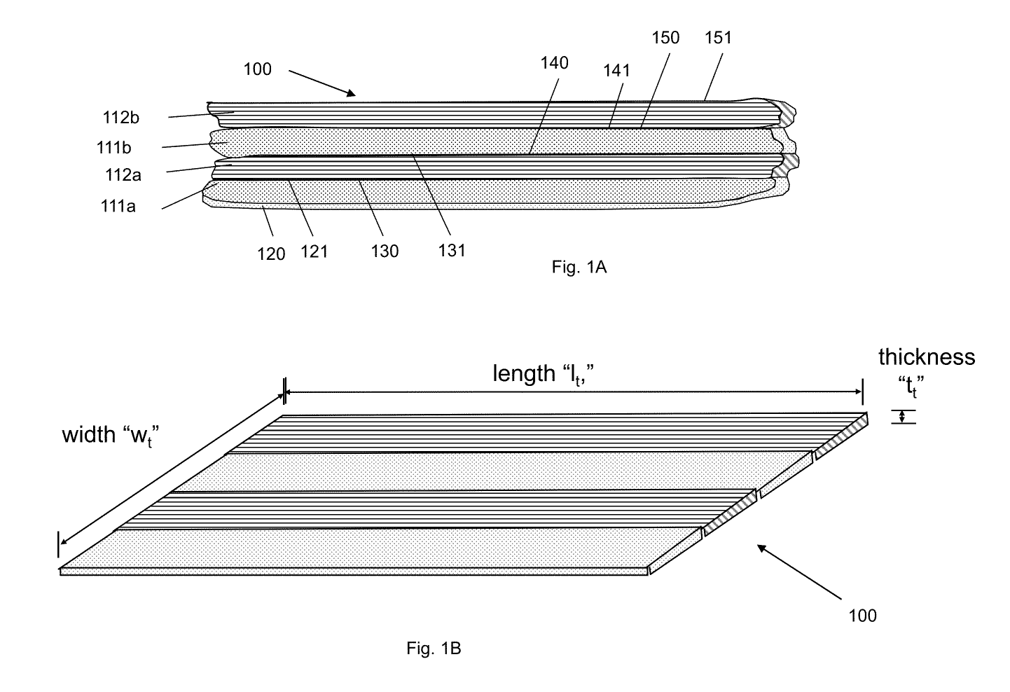

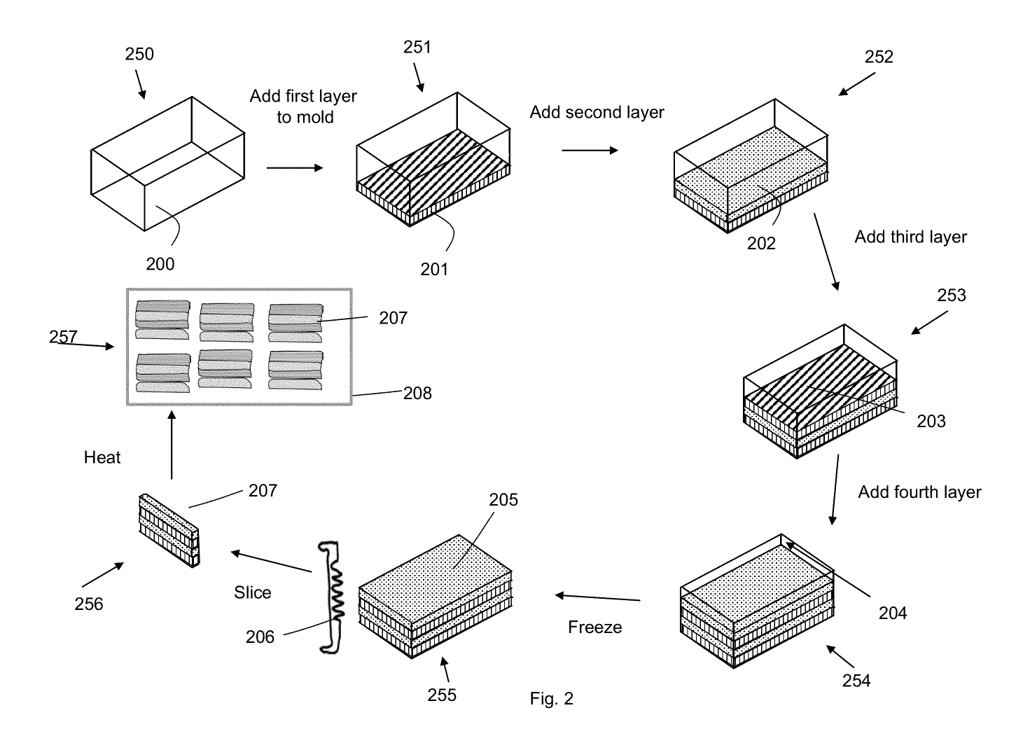

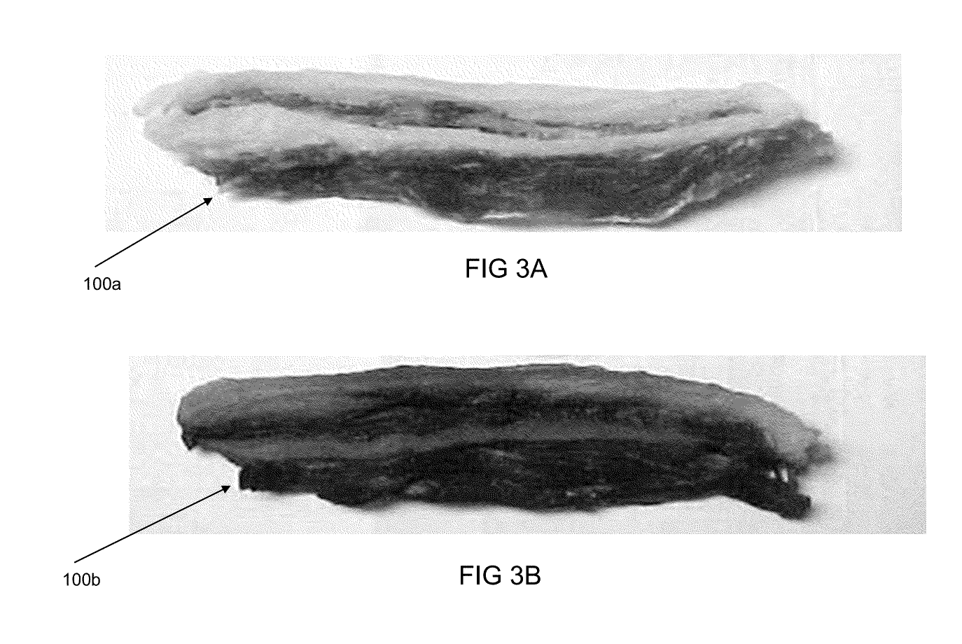

Referring now to the drawings, illustrative embodiments of a treat for carnivorous animals, e.g., domestic dogs, and methods for making are illustrated in FIG. 1A through FIG. 3B. The treat is designated generally by reference numeral 100 in FIG. 1A. A simplified schematic view to illustrate dimensional properties is illustrated in FIG. 1B. A first method of making the treat is described in conjunction with FIG. 2. Photographic examples of the treat are shown in FIGS. 3A and 3B.

In one arrangement, as shown in FIG. 1A, the treat 100 takes a form of a relatively thin element formed of at least two different segments, and can further have similar segments used arranged in an alternating manner. For ease of description, these segments are referred to herein as slice segments. In the embodiment depicted in FIGS. 1A and 1B, the treat 100 includes four slice segments 111a, 112a, 111b, and 112b. Two slice segments of a first type are indicated by reference numerals 111a and 111b. The slice segments 111a and 111b of the first type are alternated by two slice segments of a second type indicated by reference numerals 112a and 112b. These different slices segment types have different composition. In one illustrative arrangement, the slice segments 111a and 111b of the first type include chopped animal hide pieces, such as rawhide pieces, which may be dispersed in a dough-like binder. Also, in the illustrative arrangement as a contrast to the rawhide-dough mixture, the slice segments of the second type 112a and 112b contain dried meat 112a. Additional compositional details of the slice segments will be described hereinafter. While the figures depict an embodiment with four slice segments, it is recognized within the scope of the invention that alternative embodiments having more or less than four slice segments, such as any amount greater than or equal to two slice segments, could be used.

As seen in the arrangement of FIG. 1A, each slice segment 111a, 112a, 111b, and 112b has two peripheral side edges. FIG. 1A illustrates the first peripheral edge 120 and the second peripheral edge 121 for the first slice segment 111a. The second slice segment 112a has a first peripheral edge 130 and a second peripheral edge 131. The third slice segment 111b has a first peripheral edge 140 and a second peripheral edge 141. Similar to the other slice segments, the third slice segment 112b has a first peripheral edge 150 and a second peripheral edge 151.

Each slice segment 111a, 112b, 111b, and 112b is positioned adjacent to, and attached to, at least one other slice segment. More specifically, at least one peripheral side edge of each slice segment is attached to a peripheral side edge of an adjacent slice segment in an edge-to-edge manner. In the arrangement depicted in FIG. 1A, the end slice segments 111a and 112b located at the edge are attached to one adjacent slice segment 112a and 111b, respectively. The slice segments 112a and 111b in between the end segments 111a and 112b are attached to adjacent slice segments on both sides. More specifically, slice segment 112a is attached to slice segments 111a and 111b, and slice segment 111b is attached to slice segments 112a and 112b. These attachments are formed at the peripheral side edges. For example, the second peripheral edge 121 of the first slice segment 111a is in direct contact with and attached to the first peripheral edge 130 of the second slice segment 112a. The second peripheral edge 131 of the second slice segment 112a is in direct contact with and attached to the first peripheral edge 140 of the third slice segment 111b. Additionally, the first peripheral edge 141 of the third slice segment 111b is in direct contact with and attached to the first peripheral edge 150 of the fourth slice segment 112b. It is recognized, that the edges of adjacent slice segments need not be in contact with adjacent slice segments over their entire lengths.

Additionally, while the peripheral side edges of the slice segments are schematically shown as linear in FIGS. 1A and 1B, the peripheral slice segments need not be linear and the peripheral side edges will more commonly be irregular such as is shown in the embodiments depicted in FIGS. 3A and 3B. Similarly, the longitudinal ends (not labeled) of the slice segments are schematically shown as linear in FIGS. 1A and 1B, but they will more commonly be at least slightly irregular such as is shown in the embodiments depicted in FIGS. 3A and 3B.

As previously described, the slice segments 111a and 111b of the first type include chopped/granulated animal hide pieces, such as rawhide pieces. The term “rawhide” generally refers to cattle hides, however, for the specific purposes of this disclosure only “rawhide” includes the skin of all types of animals, including but not limited to, cleft foot animals, hoofed animals, bovine, livestock, buffalo, pigs, poultry, and suitable aquatic animals or fish. The rawhide need not be explicitly “raw” and may have some treatment not deleterious to carnivorous animals, particularly dogs.

More specifically, the slice segments 111a and 111b of the treat are formed of a granulated rawhide paste or dough. “Granulate rawhide” generally refers to rawhide that is cut, ground or chopped into bits or pieces. The terms chopped rawhide pieces and granulate rawhide may be used interchangeably. The rawhide pieces are part of a mixture with dough. The dough may include rice flour, alternative suitable flours, gelatin, starch, or other suitable ingredients. Agents to improve adherent or bonding properties may optionally be added. Also, if desired, the granulated rawhide paste mixture may include additives, such as coloring, flavor, vitamins, minerals, nutrients, or any other health affecting matters. According to a first illustrative embodiment, the slice segments of the first type include rawhide of at least 75% by weight. In another illustrative arrangement, the slice segments of the first type include rawhide of 75%-95% by weight. In another illustrative arrangement, the slice segments of the first type include rawhide of 80%-90% by weight. However, alternative amounts of the rawhide could be used.

The rawhide is cut or ground into bits or small pieces of a predetermined size. Any desirable average size may be used for the rawhide pieces. In one illustrative embodiment, average size of the rawhide pieces are less than 50 mm², and may be between 10 mm² and 40 mm², and may be between 30 mm² and 38 mm². However, the different or alternative sizes may be used based on a plurality of factors including the desired appearance of the treat, the optimum texture and adherence to the flavor slice segment, the ability of the bits to adhere to each other, and the source of rawhide available. Also, if desired, the source of rawhide used to make the present treat can be recycled off-cuts from other rawhide products.

As previously described, the slice segments 112a and 112b of the second type includes dried meat according to an illustrative embodiment. In one arrangement, the dried meat of the second type of slice segment is single unitary piece of meat. Unitary pieces of meat may be desired as it may provide additional meat texture to the pet. If desired, at part of the manufacturing process, the unitary piece of meat may be marinades, coated, or powdered for a flavoring enhancement. Any type of meat may be used, including but not limited to chicken, pork, lamb, beef and the like.

In an alternative arrangement to a unitary piece of meat, the meat used the second type of slice segment may be cut into small pieces (e.g., diced, ground, shredded, or minced). The “cut” meat can be mixed with a binder and/or filler such as a gelatin, starch, rice flour, or other suitable ingredients to improve adherent or bonding properties. If desired, other additives for flavoring or health benefits could be added to the cut meat mixture. In one arrangement, the amount of meat in a cut meat slice segment may be at least 80% meat by weight, at least 90% meat by weight, or at least 95% meat by weight. Any type of meat may be used, including chicken, turkey, pork, lamb, beef and the like. Alternatively, a mix of cut meats could be used. In one arrangement, the cut meat mixture for the second slice type is a mixture of chicken and pork. Combined flavors may have especially good palatability to the dog.

According to embodiments of the treat 100 with the alternating slice segments, the final treat including multiple types of slice segments include 30%-60% rawhide by weight and 30%-70% meat by weight. However, alternative compositions may be provided within the scope of the disclosure.

According to the depicted embodiment schematically shown in FIG. 1B, the treat 100 has an average width “wₜ,” an average length “lₜ,”, and an average thickness “tₜ.” Additionally, each slice segment 111a, 112b, 111b, and 112b has an average width “wₛ,” an average length “lₛ,”, and an average thickness “tₛ.” While the dimensions of the slice segments 111a, 112b, 111b, and 112b are schematically depicted in FIGS. 1A and 1B as being approximately the same, it is recognized that according to other embodiments, such as is shown in FIGS. 3A and 3B, the average lengths and average widths of the slice segments 111a, 112b, 111b, and 112b can be varied to provide the treat 100 with a more realistic simulated appearance of a slice of bacon.

Referring again to FIG. 1B, according to illustrative embodiments of the treat 100, the average length lₜ of the treat 100 is between 4 inches and 6 inches and the average width wₜ of the treat 100 is between 1.5 inches and 3 inches. According to those embodiments and alternative embodiments of the treat, the average width wₜ to average length lₜ ratio of the treat 100 is between 0.3 and 0.6. Additionally, according to illustrative embodiments of the treat 100, the average thickness tₜ of the treat 100 is less than 0.1875 inches and/or between 0.0625 inches and 0.1875 inches. According to those embodiments and alternative embodiments of the treat, the average plan area (average width wₜ times average length lₜ) to average thickness tₜ is greater than 50 in some embodiments, and greater than 100 in other embodiments.

One method of preparing an embodiment of the treat 100 is shown in FIG. 2. Specifically, a method of making a four-slice segment treat is shown. A walled mold 200 is used as a receptacle and is provided at step 250. However, used of a mold 200 is not critical. In some embodiments, the walled mold may have a bottom surface to support the slice segments. Depending up on the order of the slice segments, a first layer 201 is added to the mold at step 251. For the purposes ease of description, the first layer 201 may be a meat layer (that is for the composition of a slice segment of the second type). If the embodiment includes a unitary piece of meat for the meat slice segment, then a slab of meat is placed in the mold. Alternatively, if a cut meat mixture is used for the meat slice segment, then the mold is provide with a layer of the meat mixture such as previously described.

A second layer 202, is layered on top of the first layer 201 at step 252. Assuming the first layer 201 is a meat layer, the second layer would be a granulated rawhide paste layer as previously described. The layer 202 of the granulated rawhide paste would be provided, such as by pouring over and/or spreading on the first layer 201 in a superimposed manner.

Prior to this step and in the creation of the granulated rawhide paste, the rawhide used in the mixture may be cleaned and dry processed or wet processed in any desirable manner. That is for example, the cut rawhide may be soaked in a solution of chemicals such as hydrogen peroxide and/or ammonium chloride and rinsed to remove any chemical residue. The rawhide may then be cut into pieces of the desired size and dried. Alternatively, the rawhides can be dried, cut into pieces, and rehydrated. In yet another alternative, the rawhide may be placed in a granulating machine. However, as described above, the specific preparation method to generate the rawhide pieces are not critical to the disclosure.

A third layer 203, another meat layer in an alternating fashion, is layered on top of the second slice segment 202 at step 253 in a manner similarly described. A fourth layer 204, another granulated rawhide paste layer in an alternating fashion, is layered on top of the third layer 204 at step 254. It is recognized that the order of the layering will correspond to the number of the slice segments and the ordering of the slices segments in the embodiment of the treat to be produced as would be understood to those in the art.

During the layering process at steps 251 through 254, a manual or automated force may be provided to the top of the layer to spread the layers 201-204 in the receptacle 200 to obtain the desired treat appearance. If the layers are pressed to extend to the bounds of the receptacle 200 and created to have a substantially even thickness, the side peripheral edges of the treat 100 will be generally parallel within the variances that the different layer types will shrink at different rates when heated. However, if there are some variances in layer height, especially adjacent the receptacle 206, the side peripheral edges of the treat 100 will have an irregular appearance. The irregular appearance will further be enhanced by the fact that the different layer types will shrink at different rates when heated. As described in conjunction with FIGS. 3A and 3B, this can result in a more realistic appearance simulating a bacon slice.

After the final layer is layered, the layered composition is frozen 205 at step 255. The freezing should be done at a desired temperate for a suitable amount of time to better solidify the stacked layers to facilitate the cutting process as later described. If desired, the layered composition may be flash frozen. Once the layered composition has sufficiently been solidified and fixed for the cutting process, it may be removed from the mold 200.

The frozen composition is then sliced generally transverse to the layers (i.e., vertically) into individual slices at a desired thickness at step 256. According to some embodiments, the slices are relatively thin to produce the desired average thickness of the treat 100 after it has been heated. That is, the slices may be cut into slices of about 0.125 inches to 0.5 inches before they have been heated. The frozen composition can be cut by hand or by any desired automated or semi-automated cutting assembly. Suitable supports may be used to retain the frozen composition steady during the cutting process. In one arrangement, as schematically depicted in FIG. 3, the cutting may be done using a moving serrated blade 206.

After the frozen composition has been sliced, the individual slices 207 are placed on a suitable tray 208 or support or directly onto a grill and heated at step 257. The slices are preferably heated for a time and temperature to dehydrate and solidify the treat, and to kill any unwanted bacteria, germs, microbes, and pathogens that may be present in the slices 207. The specific temperatures and times selected are not believed to be critical. For example, drying the treat in a temperature of at least 75 degrees Celsius (167 degrees Fahrenheit) is known to kill salmonella. The treat can be heated at about 60 to 100 degrees Celsius (140 to 212 degrees Fahrenheit) for a period of about 0 to 48 hours, generally about twelve hours. Alternatively, the treat can be heated at a low temperature of about 50 to 70 degrees Celsius (122 to 158 degrees Fahrenheit) for about 1 to 4 hours to physically affect the composition of the treat, and at a higher temperature of 75 to 95 degrees Celsius (167 to 203 degrees Fahrenheit) for about 0 to 3 hours to chemically affect the composition of the treat. The temperature and time may vary depending on the size of the treat and type of heat administered.

Additionally, if desired, for the heating process, or as a secondary heating process, the slices 207 may be placed in a smoker apparatus. Based on the type of wood used in the smoker and any flavoring added, this can provide a deeper color and flavor to the finished treat 100 to provide additional visual and aromatic attraction.

FIGS. 3A and 3B include photographic images of embodiments of the treat. More specifically, the treat 100a shown in FIG. 3A has finished the heating process without the step of undergoing time in a smoker. The treat 100a shown in FIG. 3B has finished the heating process and has undergone time in a smoker. As can be seen in the images, the slice segment arrangement including their different compositions and the different drying create a treat 100, 100a, 100b that remarkably simulates the general appearance of bacon—with the treat 100b that has been smoked having a simulated general appearance of bacon that has been cooked well done.

A dog will take an initial interest in treats of the present disclosure because of visual and aromatically appeal. The methods described herein give a life-like meat appearance. The appearance derives from the layered structure and the composition of the slice segments. The desirable aroma is created from the compositions used in each slice segment. Additionally, treats disclosed herein provides several benefits. The dried meat slice segments offer good palatability and the rawhide slice segment provides extended chewing time, preventing rapid consumption of the treat by the pet and prolonging the pet's enjoyment of the treat. The treat thus combines the best qualities of pet treats—high palatability—with those of chew toys—extended chewing benefits.

Additionally, the bacon appearance is potentially advantageous due to the Pavlov effect. The Pavlov effect was first identified by Ivan Pavlov who conditioned dogs to salivate in response to stimuli such as ringing a bell. A similar effect here might occur with treat 100, 100a, 100b for dogs who have previously sensed bacon, by smell, sight, and/or taste. That is, dogs that have previously sensed bacon, by smell, sight, and/or taste might have conditioned reflexes to salivate and want the treat because they believe the treat 100, 100a, 100b is bacon due to its simulated bacon appearance and because bacon is a highly desirable food/treat.

Accordingly, in aspects of the disclosure, the layered treats may have two or more slice segments, which form the layers of the treat. Slice segments include edible foodstuffs such as rawhide compositions and dried meat compositions. In some embodiments, slice segments are alternated to provide a natural meat appearance—more specifically an appearance of bacon.

Further because of the texture of the granulated rawhide slice segment, the treat will occupy the dog for longer periods of time than a similar treat lacking the rawhide. Extended chew time advantageously provides enhanced dental benefits. Since chewing rawhide products for extended periods of time tends to reduce plaque and tartar on dogs' teeth, the treat of the present disclosure can provide enhanced reduction of plaque and tartar because dogs will tend to gnaw on the present treat for longer periods of time.

The layered approach also provides for delivery of combined flavors to the dog. Regardless of where the dog begins to gnaw on the treat, the dog will encounter multiple flavors and textures because the slice segments extend across the treat. Further, since the rawhide is cut or ground into bits or pieces, the treat is also well suited for older dogs, dogs with weak or injured jaw, and for young dogs with new teeth.

While particular embodiments of the disclosure have been shown and described, it is recognized that various modifications thereof will occur to those skilled in the art. Therefore, the scope of the herein-described invention shall be limited solely by the claims appended hereto.

What is claimed is:

1. A pet treat comprising:
a first slice segment having a first and a second peripheral side edge, wherein the first slice segment includes chopped rawhide pieces, and
a second slice segment having a first and a second peripheral side edge, wherein the second slice segment includes dried meat;
wherein the first slice segment and the second slice segment are adjacently positioned, and attached to each other, at the second peripheral side edge of the first slice segment and first peripheral side edge of the second slice segment.

2. The pet treat of claim 1 wherein the first slice further includes dried dough with the chopped rawhide pieces intermixed with the dried dough.

3. The pet treat of claim 2 wherein the first slice segment includes at least 75% chopped rawhide pieces by weight and the second slice segment includes at least 80% ground meat by weight.

4. The pet treat of claim 3 wherein the dried meat of the second slice segment includes one of dried ground meat and dried minced meat.

5. The pet treat of claim 3 further comprising a third slice segment having a first and a second peripheral side edge, wherein the third slice segment includes chopped rawhide pieces, and wherein the third slice segment and the second slice segment are adjacently positioned, and attached to each other, at the second peripheral side edge of the second slice segment and first peripheral side edge of the third slice segment.

6. The pet treat of claim 5 further comprising a fourth slice segment having a seventh and a eighth peripheral side edge, wherein the fourth slice segment includes dried meat, and wherein the fourth slice segment and the third slice segment are adjacently positioned, and attached to each other, at the second peripheral side edge of the third slice segment and first peripheral side edge of the fourth slice segment.

7. The pet treat of claim 1 further comprising:
a third slice segment having a first and a second peripheral side edge, wherein the third slice segment includes chopped rawhide pieces, and wherein the third slice segment and the second slice segment are adjacently positioned, and attached to each other, at the second peripheral side edge of the second slice segment and first peripheral side edge of the third slice segment; and
a fourth slice segment having a seventh and a eighth peripheral side edge, wherein the fourth slice segment includes dried meat, and wherein the fourth slice segment and the third slice segment are adjacently positioned, and attached to each other, at the second peripheral side edge of the third slice segment and first peripheral side edge of the fourth slice segment.

8. The pet treat of claim 7 wherein the second and fourth slice segments each contain at least 80% dried meat by weight.

9. The pet treat of claim 7 wherein the dried meat of the second and fourth slice segments is a jerky selected from the group consisting of a chicken jerky, beef jerky, and pork jerky.

10. The pet treat of claim 1 wherein second slice segment is a unitary piece of dried meat.

11. A method of making a pet treat comprising the steps of:
layering a second layer on top of a first layer, wherein one of the first and second layers includes dried meat, and the other of the first and second layers includes chopped rawhide pieces in a binder;
freezing the superimposed first and second layers; and
slicing the frozen superimposed first and second layers into relatively thin slice segments including portions of both of the first and second layers.

12. The method of claim 11 further comprising the steps of layering a third layer on top of the second layer; wherein the third layer includes dried meat or chopped rawhide pieces in a binder similar to the first layer.

13. The method of claim 12 further comprising step of heating the relatively thin slice segments.

14. The method of claim 12 further comprising the steps of layering a fourth layer on top of the third layer; wherein the fourth layer includes dried meat or chopped rawhide pieces in a binder similar to the second layer.

15. A pet treat comprising alternating slice segments of a first type and a second type, the first and second types of slice segments having compositions different form each other, wherein the first type of slice segment includes chopped rawhide pieces and the second type of slide segment includes dried meat, and wherein the pet treat has an appearance simulating the appearance of a slice of bacon.

16. The pet treat of claim 15 wherein the pet treat has an average thickness of less than or equal to 0.1875 inches.

17. The pet treat of claim 16 wherein the slice segment of the first type includes at 75% rawhide and 5% rice flour by weight and the slice segment of the second type includes at least 90% meat.

18. The pet treat of claim 17 wherein the pet treat has an average length between 4 inches and 6 inches and an average width between 1.5 inches and 3 inches.

19. The pet treat of claim 17 including at least two slice segments of the first type.

20. The pet treat of claim 17 including at least two slice segments of the second type.
